(19) United States
(12) Patent Application Publication
(10) Pub. No.: US 2024/0152954 A1
(43) Pub. Date: May 9, 2024

(54) Advanced Audience Deduplication Using Exposure Sketches and Audience Sketches

(71) Applicant: The Nielsen Company (US), LLC, New York, NY (US)

(72) Inventor: Jesse Bramble, Cincinnati, OH (US)

(21) Appl. No.: 18/502,167

(22) Filed: Nov. 6, 2023

Related U.S. Application Data
(60) Provisional application No. 63/422,819, filed on Nov. 4, 2022.

(51) Int. Cl. G06Q 30/0242; G06Q 30/0204

(52) U.S. Cl. CPC G06Q 30/0242; G06Q 30/0204

(57) ABSTRACT

In one example, a computing system of an audience measurement entity (AME) is described. The computing system is configured to perform a set of acts. The set of acts include obtaining an exposure sketch representing individuals exposed to media content, with the exposure sketch generated using sketch generation logic and AME identifiers for the individuals exposed to the media content. The set of acts also includes obtaining an audience sketch representing individuals within an audience segment, with the audience sketch generated using the sketch generation logic and AME identifiers for the individuals within the audience segment. The set of acts further includes intersecting the exposure sketch with the audience sketch using a bitwise “and” operation. The set of acts also includes determining a reach for the audience segment based on the intersecting. And the set of acts includes reporting the reach for the audience segment to a client device.

### CROSS-REFERENCE TO RELATED APPLICATIONS

This disclosure claims priority to U.S. Provisional Pat. App. No. 63/422,819, filed Nov. 4, 2022, which is hereby incorporated by reference herein in its entirety.

### SUMMARY

Advertisers want to measure media exposure of more advanced audience definitions than historic age and gender target audiences. More media companies are deciding not to allow user-level data out of their ecosystems. These media companies are sometimes comfortable using clean rooms or other privacy safe approaches such as sketches to still allow for audience reach calculations. Unfortunately, however, current sketch-based data exchanges do not allow for advanced audience segments (e.g., Automobile Brand ABC buyers) to be measured.

Disclosed herein are systems and methods to address these and potentially other issues by using an intersection of an exposure sketch and an audience sketch as a basis for determining an audience reach for an advanced audience segment.

In one aspect, a computing system of an audience measurement entity (AME) is described. The computing system includes a processor and a memory. The computing system is configured to perform a set of acts. The set of acts include obtaining an exposure sketch representing individuals exposed to media content, with the exposure sketch generated using sketch generation logic and AME identifiers for the individuals exposed to the media content. The set of acts also includes obtaining an audience sketch representing individuals within an audience segment, with the audience sketch generated using the sketch generation logic and AME identifiers for the individuals within the audience segment. The set of acts further includes intersecting the exposure sketch with the audience sketch using a bitwise “and” operation. The set of acts also includes determining a reach for the audience segment based on the intersecting. And the set of acts includes reporting the reach for the audience segment to a client device.

In another aspect, a method is described. The method includes obtaining, by a computing system of an AME, an exposure sketch representing individuals exposed to media content, with the exposure sketch generated using sketch generation logic and AME identifiers for the individuals exposed to the media content. The method also includes obtaining, by the computing system, an audience sketch representing individuals within an audience segment, with the audience sketch generated using the sketch generation logic and AME identifiers for the individuals within the audience segment. The method further includes intersecting, by the computing system, the exposure sketch with the audience sketch using a bitwise “and” operation. The method also includes determining, by the computing system, a reach for the audience segment based on the intersecting. And the method includes reporting, by the computing system, the reach for the audience segment to a client device.

In another aspect, a non-transitory computer-readable medium is described. The non-transitory computer-readable medium has stored therein instructions that when executed by a computing system of an AME cause the computing system to perform a set of acts. The set of acts includes obtaining an exposure sketch representing individuals exposed to media content, with the exposure sketch generated using sketch generation logic and AME identifiers for the individuals exposed to the media content. The set of acts also includes obtaining an audience sketch representing individuals within an audience segment, with the audience sketch generated using the sketch generation logic and AME identifiers for the individuals within the audience segment. The set of acts further includes intersecting the exposure sketch with the audience sketch using a bitwise “and” operation. The set of acts also includes determining a reach for the audience segment based on the intersecting. And the set of acts includes reporting the reach for the audience segment to a client device.

### BRIEF DESCRIPTION OF THE DRAWINGS

FIG. 1 is a conceptual illustration of an example measurement process.

FIG. 2 is a conceptual illustration of an example media presentation environment.

FIG. 3 is a process diagram illustrating example operations.

FIG. 4 is a conceptual illustration of a private identifier lookup.

FIG. 5 is a conceptual illustration of a sketch deduplication and a sketch intersection.

FIG. 6 is a flow chart of an example method.

FIG. 7 is a simplified block diagram of an example computing device.

### DETAILED DESCRIPTION

### I. Overview

As noted above, advertisers or other interested parties may want to measure media exposure of more advanced audience definitions than historic aggregated age/gender target audiences. For instance, an advertiser may wish to measure how many buyers of a particular product or service were exposed to particular media content, such as an advertisement that is part of an advertisement campaign. Such buyers are an example of an audience segment.

More generally, an audience segment is a group of individuals with similar interests or behavior. Some examples of these audience segments include repeat shoppers who spend more than a threshold amount with a company; newly acquired customers of a company who haven't made a purchase from the company yet, one-time buyers who are identified as likely to become repeat buyers based on their purchase history; and customers of a company who have not made a purchase during a recent time window.

Historically, to understand exposure of an audience segment to an advertisement, the interested party may have generated a list of individuals known to be part of an audience segment, and shared the list (e.g., in a clean room) with an AME. The AME could then compare the list with exposure data collected by the AME for the advertisement and determine an audience measurement metric. One example of an audience measurement metric is reach, which can be defined as a quantity of people that were exposed to (e.g., watched) at least a specific interval (e.g., one minute, five minutes, etc.) of a presentation of a media content item.

Increasingly, the use of sketches is becoming more common as a technique for sharing data that limits the risk of privacy leaks. By way of example, an advertiser, a media provider, or a database proprietor may be interested in collaborating with an AME, but not want to share personally identifiable information (PII) with the AME. To avoid sharing PII, the collaborating party may share a sketch with the AME.

A sketch is a probabilistic data structure that represents a collection of data in a compressed manner. The sketch provides summary information about an underlying dataset without revealing PII data for individuals that may be included in the dataset. Not only does a sketch assist in protecting the privacy of users represented by the data, but a sketch can also serve as a memory saving construct to represent the contents of relatively large databases using relatively small amounts of data. Further, not only does the relatively small size of a sketch offer advantages for memory capacity but it also reduces demands on processor capacity to analyze and/or process such data.

The challenge with current sketch-based data exchanges is that they do not allow for measuring advanced audience segments. For instance, as people access more and more media through digital means (e.g., via the internet), it is possible for online publishers and/or database proprietors that provide such media to track exposure to the media. However, database proprietors are typically only able to truck media exposure pertaining to online activity associated with the platforms operated by the database proprietors. Where media is delivered via multiple different platforms of multiple different database proprietors, no single database proprietor will be able to provide exposure metrics across the entire population to which the media was made accessible. Furthermore, such database proprietors have an interest in preserving the privacy of their users and opt to share sketches with an AME to serve that interest. Because sketches preserve privacy, it is difficult for an AME to determine the demographics of the users represented by the sketch. As a result, the AME cannot discern how many individuals represented by the sketch are part of advanced audience segments, such as buyers of a particular product or service.

Disclosed herein are systems and methods to address these and potentially other issues by using an intersection of an exposure sketch and an audience sketch as a basis for determining an audience reach for an advanced audience segment. In an example method, an exposure sketch is generated by a first party by taking a list of identifiers of media exposed individuals and flipping bits in the sketch to represent exposed individuals. The sketch is generated by leveraging sketch-generation logic. An audience sketch is then generated by a second party by taking a list of identifiers of individuals in an audience segment and flipping bits in the sketch to represent individuals in the audience segment. The audience sketch is generated by leveraging the same sketch-generation logic. Further, a computing system then intersects the exposure sketch with the audience sketch by using a bitwise “and” to determine exposures of individuals that are part of the audience segment. The computing system then calculates reach for the audience segment based on the intersection of the exposure sketch and the audience sketch, and reports the reach to a client device.

Various other features of these systems and methods are described hereinafter with reference to the accompanying figures.

### II. System Architecture

A. Measurement System

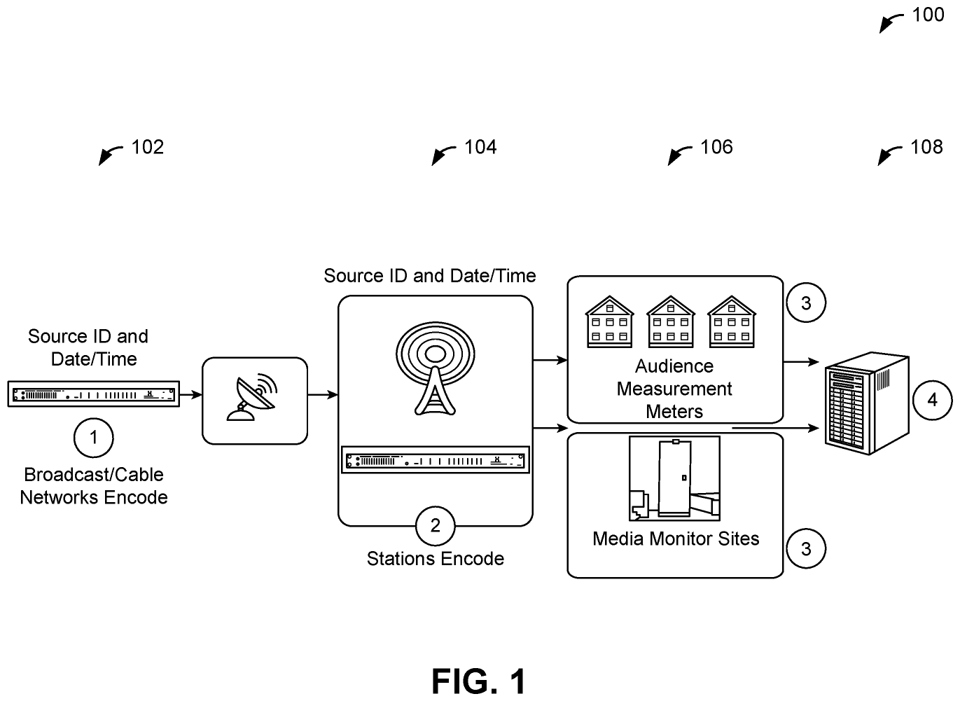

FIG. 1 is a conceptual illustration of an example measurement process 100. Measurement process 100 depicts operations that can be carried out within an audience measurement system. More specifically, FIG. 1 shows measurement process 100 as including a first stage 102, a second stage 104, a third stage 106, and a fourth stage 108.

As part of first stage 102, a broadcast/cable network encodes watermarks into media content using an encoder. A watermark is any identification information that may be inserted or embedded in the audio or video of media (e.g., a program or an advertisement) for the purpose of identifying the media. In other words, the watermark can include an audio watermark or a video watermark. In some examples, the watermark is imperceptible to humans. By way of example, during first stage 102, a television network can encode an audio watermark into media. The audio watermark can include a source identifier (e.g., a station identifier) as well as a date and/or time.

After the watermark is inserted, the broadcast/cable network distributes the watermarked media to a television station, such as a local television station for a geographic region. At second stage 104, the television station encodes watermarks into the media. For instance, the television station can encode watermarks into local media that is specific to the geographic region, such as advertisements or local programming. The television station then distributes the watermarked media to various households in the geographic region.

During third stage 106, an audience measurement meter in a panelist household monitors media content that is presented within the panelist household. For instance, the audience measurement meter detects the watermarks and decodes the watermarks so as to reveal the identification information (i.e., the source identifier and date and/or time).

The audience measurement meter then reports the identification information to a remote computing system of an AME. For instance, the audience measurement meter may be connected to a local network of the panelist household, such that the audience measurement meter can transmit the identification information to the remote computing system via the local network and the internet.

In some examples, the AME provides the audience measurement meter to the panelist household such that the audience measurement meter may be installed in a media presentation environment of the panelist household. The audience measurement meter can be installed by a panelist by simply powering the audience measurement meter and placing the audience measurement meter near a presentation device (e.g., a television). Alternatively, a field representation of the AME may visit the panelist household to install and configure the audience measurement meter.

In some examples, to monitor media presented by the presentation device, the audience measurement meter senses audio (e.g., acoustic signals or ambient audio) output by the presentation device. For example, the audience measurement meter processes the signals obtained from the media presentation device to detect media and/or source identifying signals (e.g., audio watermarks) embedded in the media presented by the presentation device. In some examples, the audience measurement meter includes a microphone array to sense ambient audio. Additionally or alternatively, the audience measurement meter may directly receive audio signals from the presentation device via a direct wired or wireless connection with the presentation device.

In some examples, the audience measurement meter can sense video output by the presentation device, and utilize video watermarking to obtain identification information for the media presented by the presentation device.

Further, instead of or in addition to detecting watermarks, the audience measurement meter can utilize fingerprint-based media identification techniques. Unlike media monitoring techniques based on watermarks included with and/or embedded in the monitored media, fingerprint-based media monitoring techniques generally use one or more inherent characteristics of the monitored media during a monitoring time interval to generate a substantially unique proxy for the media. Such a proxy is referred to as fingerprint, and can take any form representative of any aspect of the media signal (e.g., the audio and/or video signals forming the media presentation being monitored). A signature may be a series of signatures collected in series over a time interval.

Fingerprint-based media monitoring generally involves determining signatures representative of a media signal output by a monitored presentation device and comparing the monitored signatures to one or more reference signatures corresponding to known media sources. To facilitate this comparison, the audience measurement meter generates signatures, and transmits the signatures to the remote computing system of the AME. In addition, a plurality of media monitor sites receive media content distributed within a geographic region, generate reference signatures for the media content, and associate identification information with the reference signatures. The identification information can include any combination of a date/time, channel, or media identifier.

In some examples, to generate exposure data for the media, identification information for media to which the panelists in a panelist household are exposed is correlated with people data (e.g., presence information) collected by the audience measurement meter. By way of example, the audience measurement meter collects inputs (e.g., audience identification data) representative of the identities of the panelists. The audience measurement meter can collect audience identification data by periodically or a-periodically prompting panelists in the media presentation environment to identify themselves as present in the audience. Panelists can indicate their presence by pressing an appropriate key on an input device, such as a remote control, a touchscreen, or an application running on a mobile device. Alternatively, the audience measurement meter can collect audience identification data by capturing images of the media presentation environment with a camera and analyzing the images via face recognition to identify which panelist(s) are present in the media presentation environment.

During fourth stage 108, the remote computing system processes and stores data received from the audience measurement meters and optionally the media monitor sites. For example, the remote computing system combines audience identification data and identification information from multiple panelist households to generate aggregated media monitoring information. In some instances, the remote computing system generates reports for advertisers, program producers, and/or other interested parties based on the compiled statistical data. Such reports can include extrapolations about the size and demographic composition of audiences of content, channels, and/or advertisements based on the demographics and behavior of the monitored panelists. The remote computing system can leverage demographic data collected from panelists during registration of the panelists with the AME.

In examples in which the remote computing system receives reference signatures, the remote computing system can compare signatures received from panelist households with the reference signatures. Various comparison criteria, such as a cross-correlation value or a Hamming distance, can be evaluated to determine whether a monitored signature matches a particular reference signature. When a match between the monitored signature and one of the reference signatures is found, the monitored media can be identified as corresponding to the particular reference media represented by the reference signature that matched the monitored signature. Because attributes, such as an identifier of the media, a presentation time, a broadcast channel, etc., are collected for the reference signature, these attributes may then be associated with the monitored media whose monitored signature matched the reference signature.

B. Panelist Household

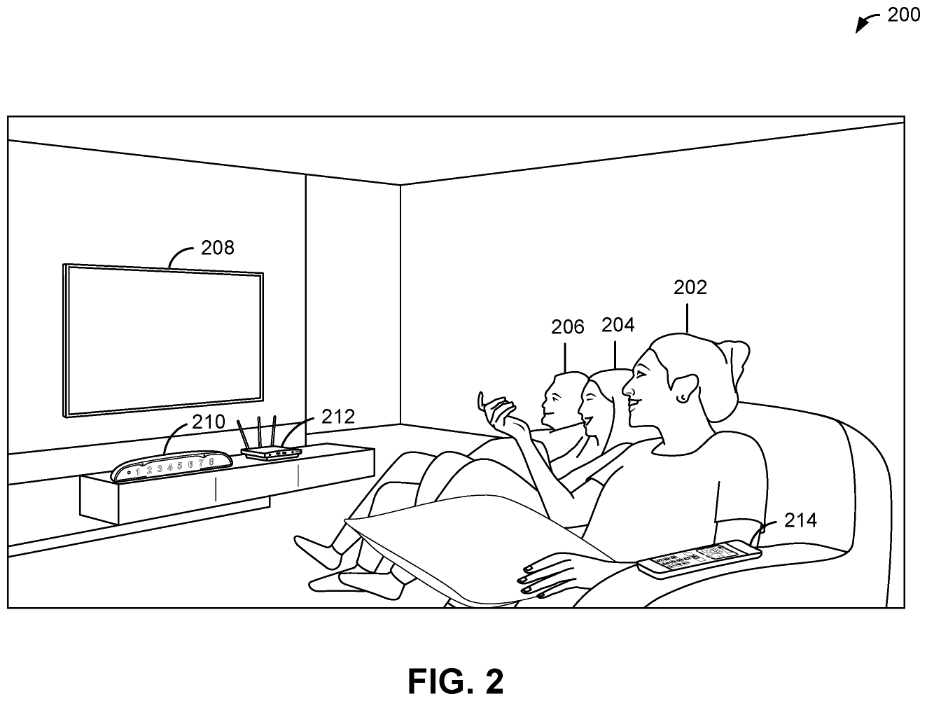

FIG. 2 is a conceptual illustration of an example media presentation environment 200. As shown in FIG. 2, media presentation environment 200 includes example panelists 202, 204, and 206, an example presentation device 208, an example audience measurement meter 210, and an example network analyzer 212. As presentation device 208 presents media content, audience measurement meter 210 generates identification information. In addition, audience measurement meter 210 collects audience identification data based on information received from a remote control 214.

In some examples, the presence of a network analyzer, such as network analyzer 212, within a panelist household allows an AME to obtain identification information for media provided to presentation device 208 via a local network of the panelist household. Because network analyzer 212 facilitates collection of identification information for streaming content, network analyzer 212 is sometimes referred to as a streaming meter or router meter. Various examples of a network analyzer are described in U.S. Pat. No. 11,102,666, titled “Methods and apparatus to monitor WI-FI media streaming using an alternate access point.” and issued Aug. 24, 2021, which is hereby incorporated by reference in its entirety.

Data collected by an AME from a panelist household can be referred to as “panel data”. In some cases, with the desire to calculate more-accurate audience measurement metrics, an AME supplements panel data with a data source having a much larger sample size relative to the panel data. This data source can include return path data (RPD) and automatic content recognition (ACR) data, which are often collectively referred to as “big data.”

RPD can include any data receivable at a media service provider, such as a cable or satellite television service provider e.g., multichannel video programming distributor (MVPD) or a streaming media service provider, via a return path to the media service provider from a media consumer site, network, or cloud (e.g., a remote digital video recorder (DVR) server). As such. RPD typically includes at least a portion of set-top box (STB) data collected by STBs. STB data may include, for example, tuning events and/or commands received by the STB (e.g., power on, power off, change channel, change input source, start presenting media, pause the presentation of media, record a presentation of media, volume up/down, etc.). Additionally or alternatively, STB data can include commands sent to a content provider by the STB (e.g., switch input sources, record a media presentation, delete a recorded media presentation, the time/date a media presentation was started, the time a media presentation was completed, etc.), heartbeat signals, or the like. Further. STB data can include a household identification (e.g. a household ID) and/or a STB identification (e.g. a STB ID). RPD can also include data from any other consumer device with network access capabilities (e.g., via a cellular network, the internet, other public or private networks, etc.). For example, RPD can include any or all of linear real-time data from an STB, guide user data from a guide server, click stream data, key stream data (e.g., any click on the remote—volume, mute, etc.), interactive activity (such as Video On Demand), and any other data (e.g., data from middleware).

ACR data, on the other hand, can include viewership data that is collected by a media device using ACR techniques (e.g., watermarking, fingerprinting, etc.). An example of such a device is a smart television (also referred to as a “Smart TV”) that is configured to connect to a network, such as the Internet, and run applications. A Smart TV might also include technology that allows advertisers to push specific advertisements to targeted households. To collect ACR data, a Smart TV can use audio (and/or video) watermarking and/or fingerprinting techniques to process media received at the Smart TV and identify that media using a reference library to which the Smart TV has access. In some cases, the ACR data can identify what media was presented by the Smart TV and when.

The AME can enter into an agreement with various data providers to access and use big data. For example, connected TV manufacturers and MVPDs can provide the AME with RPD, while Smart TV manufacturers can provide the AME with ACR data.

Similarly, the AME can obtain additional exposure data by entering into agreements with media publishers that operate walled gardens. A walled garden is a closed platform in which a media provider has control and knowledge of media content presented to individuals but does not share that information with untrusted third parties. Examples of walled gardens in the television market include Netflix and YouTube. Walled gardens share aggregated and anonymous exposure data with the AME.

The AME can also obtain exposure data by way of a direct publisher integration with a media publisher. As one example, the media publisher shares identifiers of individuals (e.g., hashed email addresses) that viewed an item of media content with the AME, and the AME uses the hashed email address to obtain demographic information for the individuals. For instance, the AME can coordinate with an identity provider (e.g., Experian) to obtain demographic information corresponding to the hashed email addresses. Additionally or alternatively, the AME can leverage an identity graph maintained by the AME to link the hashed email address with an individual or a household. An identity graph is a database that stores and associates identification data related to a household or a device. For instance, an identity graph can associate a hashed email address (and/or other identifiers) with a particular household and/or a computing device. Direct publisher integrations sometimes make use of privacy-preservation systems such as clean room exchanges.

Walled garden and direct publisher integrations also allow the AME to obtain exposure data corresponding to media content presented via mobile or desktop applications operating on mobile devices or personal computers, respectively.

In some examples, the AME can collect exposure data corresponding to presentation of media content presented on web pages. Exposure data for such media content can be referred to as “open web” exposure data. In some examples, an AME leverages beacon instructions embedded in web pages to collect open web exposure data. Beacon instructions cause monitoring data reflecting information access to media to be sent from a client device that downloaded the media to a monitoring entity, such as a collection server controlled by the AME. Advantageously, because the beacon instructions are associated with the media and executed by the client device whenever the media is accessed, the monitoring information is provided to the audience measurement company irrespective of whether the client is a panelist of the audience measurement company. Further, the AME can use agreements with database proprietors to obtain demographic information corresponding to such exposure data. Additional details regarding open web exposure data and beacon instructions are disclosed in U.S. Pat. No. 10,536,543, titled “Methods and apparatus to share online media impression data”, issued Jan. 14, 2020, which is hereby incorporated by reference in its entirety.

### III. Example Operations

In line with the discussion above, a computing system of an AME can be configured to perform one or more operations to determine an audience reach for an advanced audience segment. Examples of these operations and related features will now be described.

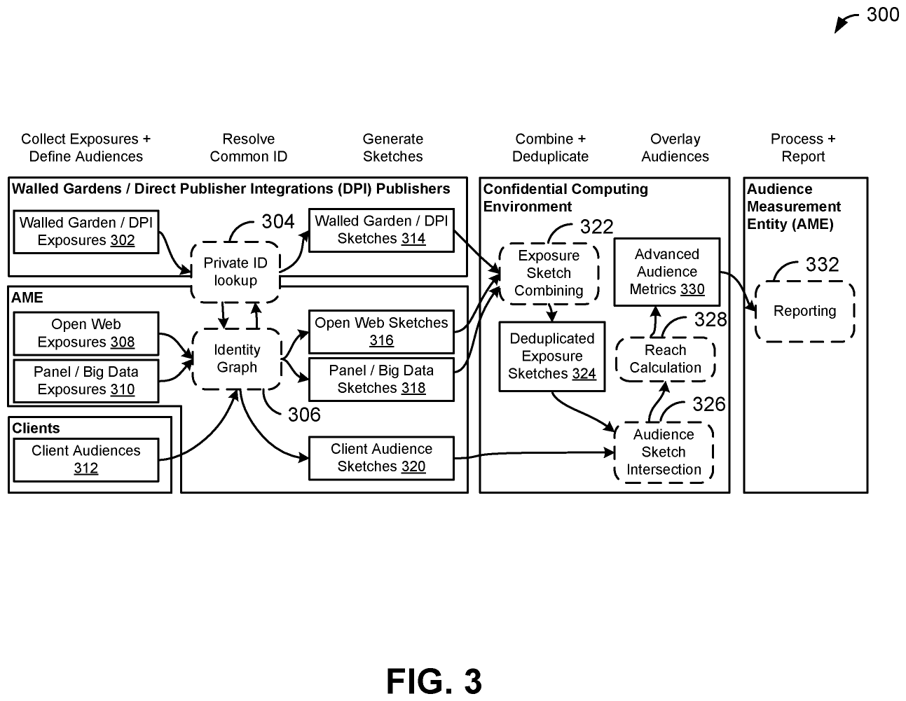

FIG. 3 is a process diagram illustrating example operations. As shown in FIG. 3, various operations are spread across different computing systems, namely, walled gardens and/or media publishers having direct publisher integrations with the AME, client computing systems, the AME computing system, and a confidential computing environment.

A confidential computing environment (CCE) is an environment that aims to enhance data privacy and security by providing encrypted computation on sensitive data and isolating data from apps and other host resources in a fenced off enclave during processing. For example, the AME can implement the confidential computing environment within an enclave provided by remote cloud server. Although FIG. 3 illustrates the CCE, other example systems can carry out the operations without use of a CCE. For instance, operations depicted as part of the CCE can be carried out by the AME.

In line with the discussion above, media publishers operating as walled gardens or having direct publisher integrations (DPIs) with the AME collect exposures indicative of exposure of individuals to media content. For ease of explanation, this media content is referred to hereinafter as an advertisement. However, the media content could be one of multiple advertisements that are part of an advertisement campaign. Or the media content could be a program, or one of a group of programs. Further, these exposures are referred to as walled garden/DPI exposures 302. The walled garden/DPI exposures 302 are linked to walled garden/DPI identifiers known by the walled garden/DPI, such as hashed email addresses of the individuals that were exposed to the media content.

In some examples, a media publisher with walled garden exposures engages in a private identifier (ID) lookup 304 with the AME to obtain AME identifiers that are mapped to exposure identifiers. The private ID lookup 304 can occur in various ways. By way of example, the media publisher and the AME can use a double-blind match to match exposure identifiers to corresponding AME identifiers. As part of the double-blind match, the media publisher can encrypt the exposure identifiers, and the AME can encrypt individual identifiers known by the AME. The exposure identifiers and the individual identifiers can both be hashed email addresses, for instance. A trusted-third party system, such as a computing system controlled by the AME or a computing system controlled by the media publisher, can then identify matches between the two sets of encrypted identifiers. The trusted third party then generates a list of matching records, and informs of the AME of the encrypted AME identifiers that were identified as matching to an exposure identifier.

The AME then determines the individual identifiers (e.g., hashed email addresses) corresponding to the encrypted identifiers. Further, the AME determines AME identifiers linked to the individual identifiers. The AME identifier is a persistent identifier that represents a unique individual or a unique household. The AME can use an identity graph 306 to link individual identifiers to AME identifiers. After generating a list of AME identifiers, the AME sends the list of AME identifiers to the media publisher.

The private ID lookup 304 could occur in other manners as well, such as through use of a clean room operated by the media publisher or the AME. As part of the clean room, the AME and the media publisher can securely share and analyze data with full control of how, where, and when that data can be used. For instance, the AME can upload individual identifiers to the clean room, and the media publisher can upload exposure identifiers to the clean room. Software operating on the data in the clean room can then determine which individual identifiers match to the exposure identifiers, and provide an aggregated list of individual identifiers to the AME. The AME can then use the aggregated list of individual identifiers to determine a list of AME identifiers, and send the list of AME identifiers to the media publisher.

Likewise, other media publishers operating as walled gardens and/or having DPIs with the AME can conduct similar private ID lookups, such that the media publishers obtain lists of AME identifiers indicative of individuals or households exposed to the advertisement.

The AME can also use identity graph 306 to link open web exposures 308 and panel/big data exposures 310 for the advertisement with AME identifiers.

Moreover, a client (e.g., an advertiser, a brand, or other interested party) interacts with the AME computing system to obtain AME identifiers corresponding to the list of client identifiers. In some examples, a client computing system generates a client audience 312, such as a list of individual identifiers for an audience segment. The list of identifiers can include hashed email addresses. Or the list of identifiers can include third-party identifiers corresponding to individuals, such as identifiers provided by an identity partner (e.g., Experian). The client computing system then engages in a private ID lookup with the AME computing system to obtain a list of AME identifiers corresponding to the individual identifiers. This private ID lookup can be similar to the private ID lookup 304.

Alternatively, the client computing system can use an audience builder tool to generate a list of AME identifiers. The audience builder tool can include software that displays a list of demographic filters on the client computing system, and allows an operator of the client computing system to use the demographic filters to create a custom audience segment for which the client would like to obtain audience measurement metrics. Example of demographic filters include ethnicity, household income, device types inside the home, and location. After the client computing system obtains filter criteria, the client computing system sends the filter criteria to the AME computing system. The AME computing system uses the filter criteria to identify AME identifiers for individuals or households meeting the filter criteria, and stores the AME identifiers as a client audience.

After obtaining AME identifiers for walled garden/DPI exposures, the media publisher(s) generates walled garden/DPI sketches 314. In line with the discussion above, a sketch is a probabilistic data structure that represents a collection of data in a compressed manner. A media publisher can generate a walled garden/DPI sketch using sketch generation logic. By way of example, the media publisher can generate a Bloom filter array using the technique described in U.S. patent application Ser. No. 17/362,404, filed Jun. 29, 2021, titled “Methods and apparatus to estimate cardinality across multiple datasets represented using bloom filter arrays,” which is hereby incorporated by reference in its entirety. As another example, the media publisher can generate a Bloom filter array using the non-uniform Bloom filter technique described in U.S. patent application Ser. No. 17/007,774, filed Aug. 31, 2020, titled “Methods and apparatus to estimate cardinality of users represented in arbitrarily distributed bloom filters,” which is hereby incorporated by reference in its entirety.

A Bloom filter array is a vector or array of bits that are initialized to zero and then populated by flipping individual ones of the bits from zero to one based on the allocation or assignment of AME identifiers to respective ones of the bits in the Bloom filter array. The process of generating a Bloom filter array representative of AME identifiers can involve initializing a vector having a desired length, with all values being initialized to zero. A hash function is then applied to an AME identifier. The result of the hash function is indicative of a particular bit or element in the Bloom filter array to which the corresponding AME is mapped. The hash function is designed to map a particular input to one and only one element in the Bloom filter array. Based on the mapping to a particular bit, the value of that bit is flipped from zero to one. In some instances, multiple hash functions are applied to an AME identifier, such that the AME identifier maps to a group of bits or elements in the Bloom filter array.

Similarly, the AME computing system can generate one or more open web sketches 316 using the same hash function(s) to map AME identifiers of the open web exposures 308 to particular elements of a separate Bloom filter array. The AME computing system can likewise generate one or more panel/big data sketches 318 by using the same hash function to map AME identifiers of the panel/big data exposures to particular elements of a separate Bloom filter array. Further, the AME computing system can generate one or more client audience sketches 320 by using the same hash function to map AME identifiers corresponding to the client audiences 312 to particular elements of a separate Bloom filter array.

By design, the media publishers' computing systems and the AME computing system use the same sketch generation logic (e.g., same hash function(s) and sketch length) such that the sketches are comparable and can be processed in sketch space. Other types of sketches and corresponding logic could also be utilized, such as HyperLogLog sketches. Example HyperLogLog sketch generation logic is described in U.S. patent application Ser. No. 16/520,100, filed Jul. 23, 2019, tided “Methods and apparatus to determine a unique audience for internet-based media,” which is hereby incorporated by reference in its entirety.

At block 322, the AME can combine exposure sketches in the CCE. As one example, the AME can combine any combination of one or more walled garden sketches, one or more DPI sketches, one or more open web sketches, one or more panel sketches, or one or more big data sketches. Combining exposure sketches can involve obtaining a first exposure sketch from a first exposure source, obtaining a second exposure sketch from a second exposure sketch that is different from the first exposure source, and combining the first exposure sketch and the second exposure sketch using a bitwise “or” operation so as to obtain a deduplicated exposure sketch 324. For instance, the first exposure source can be a first publisher that does not provide respondent-level data, and the second exposure source can be a second publisher that does not provide respondent-level data. Or the first exposure source can be panel data collected by the AME, and the second exposure source be an RPD source or an ACR data source.

At block 326, the AME can intersect the deduplicated exposure sketches 324 with the client audience sketches 320. For instance, the AME can intersect the deduplicated exposure sketches 324 with the client audience sketches 320 using a bitwise “and” operation.

By understanding the intersection of the deduplicated exposure sketches 324 and the client audience sketches 320, the AME computing system can determine advanced audience metrics. For instance, at block 328, the AME computing system can determine a reach for the advertisement based on the intersecting. Even though the membership of a particular individual/household within a particular dataset represented by a Bloom filter array cannot be guaranteed with confidence, due to the nature in which individuals/households are allocated to different elements in the array, it is possible to reliably estimate the cardinality or total number of unique individuals/households represented by the audience sketch intersection. One approach for estimating reach leverages the inclusion-exclusion principle to generate an analytical expression for reach, as detailed in U.S. patent application Ser. No. 17/362,404. One of ordinary skill in the art will appreciate that other cardinality-estimation techniques can similarly be employed. The result of the reach calculation is advanced audience metrics 330.

Further, at block 332, the AME computing system can report the advanced audience metrics. In some examples, reporting the advanced audience metrics involves storing data in a database of the AME. The data is usable by the AME computing system to render a dashboard on a display device of the client computing system. For instance, the dashboard can visually represent the reach for the advertisement. The client computing system can access the dashboard through a web browser of an application running on a computing device. In some examples, reporting the advanced audience metrics involves generating a report, and transmitting the report to the client computing system.

In some instances, the exposure sketches provided by the media publishers and the exposure sketches generated by the AME are specific to exposures on respective device platforms (e.g., linear television, connected TV, mobile devices, personal computers). With this approach, the AME computing system can intersect the exposure sketches with a client audience sketch, and generate respective audience metrics for each device platform. This allows the AME computing system to report on reach for each device platform.

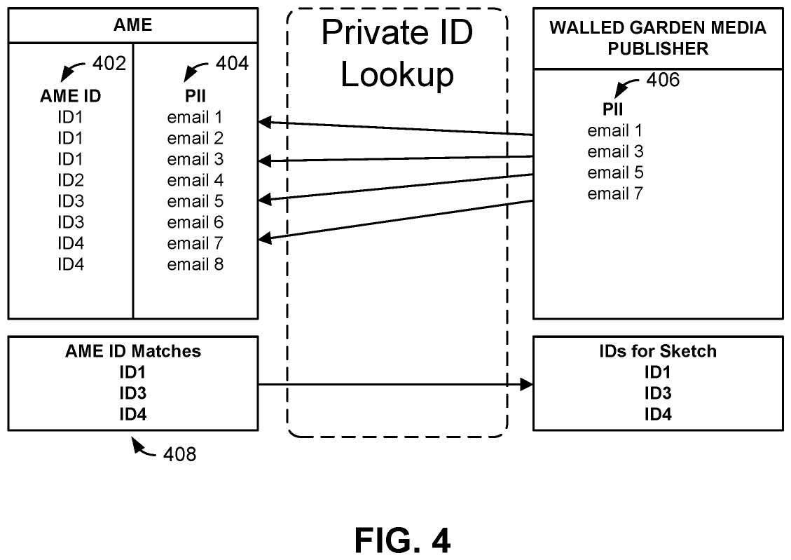

FIG. 4 is a conceptual illustration of a private ID lookup. As shown in FIG. 4, an AME stores data linking first email addresses 402 with corresponding first AME identifiers 404. Further, a media publisher operating as a walled garden stores second email addresses 406 corresponding to individuals/households exposed to an advertisement. Through use of a private ID lookup, the AME computing system, the media publisher computing system, or trusted third-party computing system matches email addresses within the second email addresses 406 to email addresses within the first email addresses 402. AME identifiers 408 for the matching email addresses are then identified, and the walled garden media publisher is informed of the AME identifiers for use in generating an exposure sketch. Although FIG. 4 depicts PII in the form of email addresses, the example is not meant to be limiting. In other examples, the PII could be identifiers of an identity partner (e.g., Experian IDs).

Further, although FIGS. 3 and 4 reference a private ID lookup, in some systems, the matching can be carried out without use of a private ID lookup. For instance, hashed email addresses could be used rather than performing a private ID lookup. By way of example, the first AME identifiers can include hashed email addresses. With this approach, the media publisher operating as the walled garden can hash its email addresses using a similar algorithm, and provide the hashed email addresses to the AME for matching with the AMEs hashed email addresses.

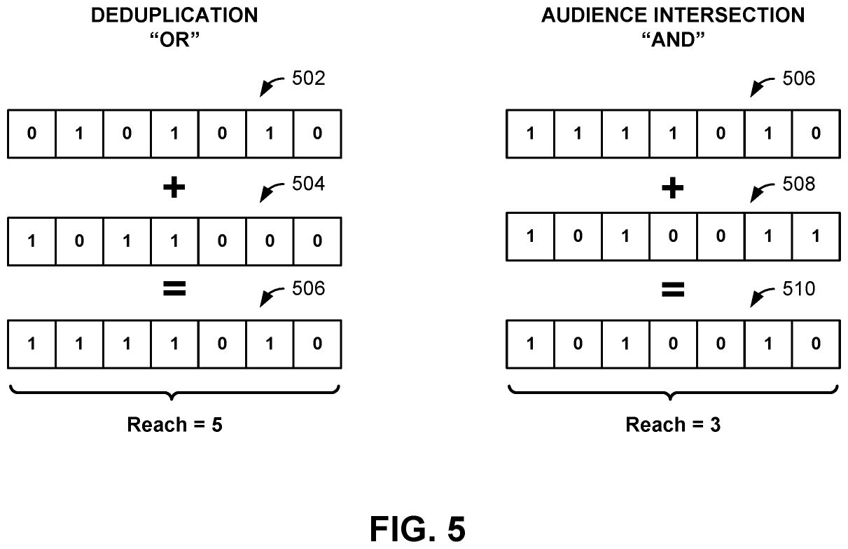

FIG. 5 is a conceptual illustration of a sketch deduplication and a sketch intersection. As shown in FIG. 5, a first exposure sketch 502 is overlayed at each bit with a second exposure sketch 504 using bitwise “or” logic, resulting in a combined exposure sketch 506. As part of the combination, each bit in the combined exposure sketch 506 is set to one if the corresponding bit in the first exposure sketch 502, the corresponding bit in the second exposure sketch, or both are one. For a simplified example in which each bit corresponds to a single individual/household, the combined exposure sketch 506 is indicative of a unique audience or reach of five.

As further shown in FIG. 5, the combined exposure sketch 506 is overlayed at each bit with an advanced audience sketch 508 using bitwise “and” logic, resulting in an intersection sketch 510. As part of the intersection, each bit in the intersection sketch 510 is set to one if the corresponding bit in the combined exposure sketch 506 and the corresponding bit in the advanced audience sketch 508 are one. Continuing with the simplified example above, the intersection sketch 510 can be interpreted as a unique audience or reach of three. In other words, out of the five unique individuals/households exposed to the advertisement, only three of the individuals/households are in the advanced audience segment.

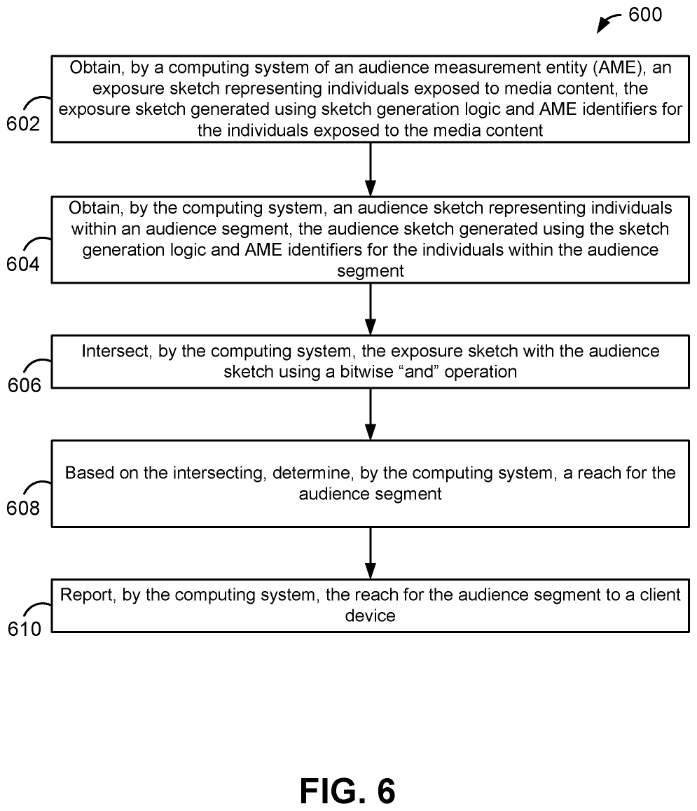

FIG. 6 is a flow chart of an example method 600. Method 600 can be carried out by a computing system of an audience measurement entity. At block 602, method 600 includes obtaining an exposure sketch representing individuals exposed to media content. The exposure sketch is generated using sketch generation logic and AME identifiers for the individuals exposed to the media content. At block 604, method 600 includes obtaining an audience sketch representing individuals within an audience segment. The audience sketch is generated using the sketch generation logic and AME identifiers for the individuals within the audience segment. At block 606, method 600 includes intersecting the exposure sketch with the audience sketch using a bitwise “and” operation. At block 608, method 600 includes based on the intersecting, determining a reach for the audience segment. And at block 610, method 600 includes reporting the reach for the audience segment to a client device.

### IV. Example Computing Device

Any one or more of the above-described components, such as the computing system of the AME, the audience measurement meter, and the network analyzer, can take the form of a computing device, or a computing system that includes one or more computing devices.

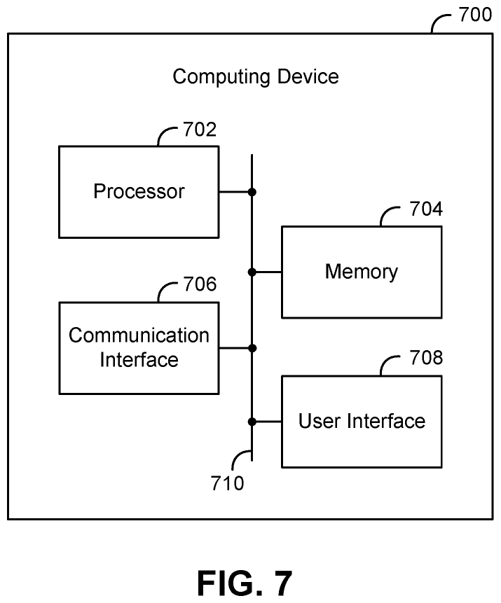

FIG. 7 is a simplified block diagram of an example computing device 700. The computing device 700 can be configured to perform one or more operations, such as the operations described in this disclosure. As shown, the computing device 700 can include various components, such as a processor 702, memory 704, a communication interface 706, and/or a user interface 708. These components can be connected to each other (or to another device, system, or other entity) via a connection mechanism 710.

The processor 702 can include one or more general-purpose processors and/or one or more special-purpose processors.

Memory 704 can include one or more volatile, non-volatile, removable, and/or non-removable storage components, such as magnetic, optical, or flash storage, and/or can be integrated in whole or in part with the processor 702. Further, memory 704 can take the form of a non-transitory computer-readable storage medium, having stored thereon computer-readable program instructions (e.g., compiled or non-compiled program logic and/or machine code) that, upon execution by the processor 702, cause the computing device 700 to perform one or more operations, such as those described in this disclosure. The program instructions can define and/or be part of a discrete software application. In some examples, the computing device 700 can execute the program instructions in response to receiving an input (e.g., via the communication interface 706 and/or the user interface 708). Memory 704 can also store other types of data, such as those types described in this disclosure. In some examples, memory 704 can be implemented using a single physical device, while in other examples, memory 704 can be implemented using two or more physical devices.

The communication interface 706 can include one or more wired interfaces (e.g., an Ethernet interface) or one or more wireless interfaces (e.g., a cellular interface, Wi-Fi interface, or Bluetooth® interface). Such interfaces allow the computing device 700 to connect with and/or communicate with another computing device over a computer network (e.g., a home Wi-Fi network, cloud network, or the Internet) and using one or more communication protocols. Any such connection can be a direct connection or an indirect connection, the latter being a connection that passes through and/or traverses one or more entities, such as a router, switcher, server, or other network device. Likewise, in this disclosure, a transmission of data from one computing device to another can be a direct transmission or an indirect transmission.

The user interface 708 can facilitate interaction between computing device 700 and a user of computing device 700, if applicable. As such, the user interface 708 can include input components such as a keyboard, a keypad, a mouse, a touch-sensitive panel, a microphone, and/or a camera, and/or output components such as a display device (which, for example, can be combined with a touch-sensitive panel), a sound speaker, and/or a haptic feedback system. More generally, the user interface 708 can include hardware and/or software components that facilitate interaction between the computing device 700 and the user of the computing device 700.

The connection mechanism 710 can be a cable, system bus, computer network connection, or other form of a wired or wireless connection between components of the computing device 700.

One or more of the components of the computing device 700 can be implemented using hardware (e.g., a digital signal processor (DSP), an application-specific integrated circuit (ASIC), a field-programmable gate array (FPGA), another programmable logic device, or discrete gate or transistor logic), software executed by one or more processors, firmware, or any combination thereof. Moreover, any two or more of the components of the computing device 700 can be combined into a single component, and the function described herein for a single component can be subdivided among multiple components.

### V. Example Variations

Although the examples and features described above have been described in connection with specific entities and specific operations, in some scenarios, there can be many instances of these entities and many instances of these operations being performed, perhaps contemporaneously or simultaneously, on a large-scale basis.

In addition, although some of the operations described in this disclosure have been described as being performed by a particular entity, the operations can be performed by any entity, such as the other entities described in this disclosure. Further, although the operations have been recited in a particular order and/or in connection with example temporal language, the operations need not be performed in the order recited and need not be performed in accordance with any particular temporal restrictions. However, in some instances, it can be desired to perform one or more of the operations in the order recited, in another order, and/or in a manner where at least some of the operations are performed contemporaneously/simultaneously. Likewise, in some instances, it can be desired to perform one or more of the operations in accordance with one more or the recited temporal restrictions or with other timing restrictions. Further, each of the described operations can be performed responsive to performance of one or more of the other described operations. Also, not all of the operations need to be performed to achieve one or more of the benefits provided by the disclosure, and therefore not all of the operations are required.

Although certain variations have been described in connection with one or more examples of this disclosure, these variations can also be applied to some or all of the other examples of this disclosure as well and therefore aspects of this disclosure can be combined and/or arranged in many ways. The examples described in this disclosure were selected at least in part because they help explain the practical application of the various described features.

Also, although select examples of this disclosure have been described, alterations and permutations of these examples will be apparent to those of ordinary skill in the art. Other changes, substitutions, and/or alterations are also possible without departing from the invention in its broader aspects as set forth in the following claims.

1. A computing system of an audience measurement entity (AME), the computing system comprising a processor and a memory, the computing system configured to perform a set of acts comprising:
obtaining an exposure sketch representing individuals exposed to media content, the exposure sketch generated using sketch generation logic and AME identifiers for the individuals exposed to the media content;
obtaining an audience sketch representing individuals within an audience segment, the audience sketch generated using the sketch generation logic and AME identifiers for the individuals within the audience segment;
intersecting the exposure sketch with the audience sketch using a bitwise “and” operation;
based on the intersecting, determining a reach for the audience segment; and
reporting the reach for the audience segment to a client device.

2. The computing system of claim 1, wherein the set of acts further comprises:
obtaining client audience data comprising identifiers for the individuals within the audience segment;
mapping the identifiers for the individuals within the audience segment to the AME identifiers for the individuals within the audience segment; and
generating the audience sketch using the AME identifiers for the individuals within the audience segment.

3. The computing system of claim 2, wherein mapping the identifiers for the individuals within the audience segment to the AME identifiers for the individuals within the audience segment comprises mapping the identifiers for the individuals within the audience segment to the AME identifiers for the individuals within the audience segment using an identity graph maintained by the AME.

4. The computing system of claim 1, wherein obtaining the exposure sketch comprises:
obtaining a first exposure sketch from a first exposure source;
obtaining a second exposure sketch from a second exposure source that is different from the first exposure source; and
combining the first exposure sketch and the second exposure sketch using a bitwise “or” operation so as to obtain the exposure sketch.

5. The computing system of claim 4, wherein:
the first exposure source is a first publisher that does not provide respondent-level data, and
the second exposure source is a second publisher that does not provider respondent-level data.

6. The computing system of claim 4, wherein:
the first exposure source is panel data collected by the AME, and
the second exposure source is a return path data source or an automatic content recognition data source.

7. The computing system of claim 1, wherein the audience segment is a group of individuals identified as being interested in a given product or service.

8. A method comprising:
obtaining, by a computing system of an audience measurement entity (AME), an exposure sketch representing individuals exposed to media content, the exposure sketch generated using sketch generation logic and AME identifiers for the individuals exposed to the media content;
obtaining, by the computing system, an audience sketch representing individuals within an audience segment, the audience sketch generated using the sketch generation logic and AME identifiers for the individuals within the audience segment;
intersecting, by the computing system, the exposure sketch with the audience sketch using a bitwise “and” operation;
based on the intersecting, determining, by the computing system, a reach for the audience segment; and
reporting, by the computing system, the reach for the audience segment to a client device.

9. The method of claim 8, further comprising:
obtaining client audience data comprising identifiers for the individuals within the audience segment;
mapping the identifiers for the individuals within the audience segment to the AME identifiers for the individuals within the audience segment; and
generating the audience sketch using the AME identifiers for the individuals within the audience segment.

10. The method of claim 9, wherein mapping the identifiers for the individuals within the audience segment to the AME identifiers for the individuals within the audience segment comprises mapping the identifiers for the individuals within the audience segment to the AME identifiers for the individuals within the audience segment using an identity graph maintained by the AME.

11. The method of claim 8, wherein obtaining the exposure sketch comprises:
obtaining a first exposure sketch from a first exposure source;
obtaining a second exposure sketch from a second exposure source that is different from the first exposure source; and
combining the first exposure sketch and the second exposure sketch using a bitwise “or” operation so as to obtain the exposure sketch.

12. The method of claim 11, wherein:
the first exposure source is a first publisher that does not provide respondent-level data, and
the second exposure source is a second publisher that does not provider respondent-level data.

13. The method of claim 11, wherein:
the first exposure source is panel data collected by the AME, and
the second exposure source is a return path data source or an automatic content recognition data source.

14. The method of claim 11, wherein the audience segment is a group of individuals identified as being interested in a given product or service.

15. A non-transitory computer-readable medium having stored therein instructions that when executed by a computing system of an audience measurement entity (AME) cause the computing system to perform a set of acts comprising:
obtaining an exposure sketch representing individuals exposed to media content, the exposure sketch generated using sketch generation logic and AME identifiers for the individuals exposed to the media content;
obtaining an audience sketch representing individuals within an audience segment, the audience sketch generated using the sketch generation logic and AME identifiers for the individuals within the audience segment;
intersecting the exposure sketch with the audience sketch using a bitwise “and” operation;
based on the intersecting, determining a reach for the audience segment; and
reporting the reach for the audience segment to a client device.

16. The non-transitory computer-readable medium of claim 15, wherein the set of acts further comprises:
obtaining client audience data comprising identifiers for the individuals within the audience segment;
mapping the identifiers for the individuals within the audience segment to the AME identifiers for the individuals within the audience segment; and
generating the audience sketch using the AME identifiers for the individuals within the audience segment.

17. The non-transitory computer-readable medium of claim 16, wherein mapping the identifiers for the individuals within the audience segment to the AME identifiers for the individuals within the audience segment comprises mapping the identifiers for the individuals within the audience segment to the AME identifiers for the individuals within the audience segment using an identity graph maintained by the AME.

18. The non-transitory computer-readable medium of claim 15, wherein obtaining the exposure sketch comprises:
obtaining a first exposure sketch from a first exposure source;
obtaining a second exposure sketch from a second exposure source that is different from the first exposure source; and
combining the first exposure sketch and the second exposure sketch using a bitwise “or” operation so as to obtain the exposure sketch.

19. The non-transitory computer-readable medium of claim 18, wherein:
the first exposure source is a first publisher that does not provide respondent-level data, and
the second exposure source is a second publisher that does not provider respondent-level data.

20. The non-transitory computer-readable medium of claim 18, wherein:
the first exposure source is panel data collected by the AME, and
the second exposure source is a return path data source or an automatic content recognition data source.
